(19) United States
(12) Patent Application Publication
(10) Pub. No.: US 2010/0021723 A1
(43) Pub. Date: Jan. 28, 2010

(54) "Layered product with high thermal insulation and self-extinguishing capacity"

(75) Inventor: Roberto Fantino, Peschiera Borromeo (IT)

Correspondence Address: MODIANO & ASSOCIATI, Via Meravigli, 16, MILANO, 20123, IT

(73) Assignee: NAT STYLE LIMITED

(21) Appl. No.: 12/289,926

(22) Filed: Nov. 7, 2008

(30) Foreign Application Priority Data
Jul. 24, 2008 (IT) MI2008A001354

(51) Int. Cl. B32B 5/02

(52) U.S. Cl. 428/332; 428/221; 428/340

(57) ABSTRACT

A layered product with high thermal insulation and self-extinguishing capacity, particularly for blankets and bed accessories, upholstery, coverings, items of clothing and the like, comprising a first layer constituted by a fabric obtained with a yarn provided by an intimate mix of cellulose fiber and phenolic fiber, the first layer being superimposed on an intermediate layer made of a phenolic fiber cotton wool, a second layer being further provided which is constituted by a fabric obtained with a cellulose fiber yarn associated with the intermediate layer on the opposite side with respect to the first layer, means for joining the layers being further provided.

### BACKGROUND OF THE INVENTION

The present invention relates to a layered product with high thermal insulation and self-extinguishing capacity.

As is known, many fields of application, such as blankets, bed accessories, upholstery, coverings, items of clothing and the like, use materials which contain flame retardants capable of limiting or inhibiting flame propagation.

This characteristic is obtained generally by means of fireproofing treatments during textile enhancement. This particularity tends, over a period of use and as a consequence of maintenance, to reduce its efficiency levels.

Moreover, known solutions are unable to provide protection in the transfer of heat in the presence of sources of convective flame and/or irradiation with sufficiently significant levels.

Another problem is constituted by the fact that when the textile elements with which the products cited above are made undergo combustion, they release noxious gases and fumes of various compositions, even emitting toxic gases.

During combustion, most of the fibers that are currently used and the flame-retardant treatments that are applied to textiles emit hydrocyanic acid, halogens, sulfur dioxide and so forth, and accordingly in confined space or more simply in a dwelling house this phenomenon is in itself a risk-increasing factor.

### SUMMARY OF THE INVENTION

The aim of the invention is to solve the problems cited above by providing a layered product particularly suitable for blankets, bed accessories, upholstery, coverings, items of clothing and the like with high thermal insulation and self-extinguishing capacity, which is obtained from per se known elements which are assembled to obtain an assembly which does not produce noxious or toxic fumes and gases during combustion.

Within this aim, an object of the invention is to provide a layered product which, in addition to providing adequate insulation against flames and heat, is capable of giving particular aesthetic features, pleasantness to the touch, and softness, so as to meet even the most demanding requirements of fashion.

Another object of the present invention is to provide a layered product which, thanks to its particular constructive characteristics, provides the greatest assurances of reliability and safety in use.

Another object of the present invention is to provide a layered product with high thermal insulation capacity which can be obtained easily starting from commonly commercially available elements and materials and is also competitive from a merely economic standpoint and combines particular technical characteristics also with aesthetic and comfort qualities.

This aim and these and other objects which will become better apparent hereinafter are achieved by a layered product with high thermal insulation and self-extinguishing capacity according to the invention, characterized in that it comprises a first layer constituted by a fabric obtained with a yarn provided by means of an intimate mix of cellulose fiber and phenolic fiber, said first layer being superimposed on an intermediate layer made of a phenolic fiber cotton wool, a second layer being further provided which is constituted by a fabric obtained with a cellulose fiber yarn associated with said intermediate layer on the opposite side with respect to said first layer, means for joining said layers being further provided.

### BRIEF DESCRIPTION OF THE DRAWINGS

Further characteristics and advantages will become better apparent from the description of a preferred but not exclusive embodiment of a layered product with high thermal insulation and self-extinguishing capacity, illustrated by way of non-limiting example in the accompanying drawings, wherein:

FIG. 1 is a schematic perspective view of a layered product such as a blanket;

FIG. 2 is a view of the layered product, illustrating the layers that constitute it;

FIG. 3 is a sectional view of the layered product.

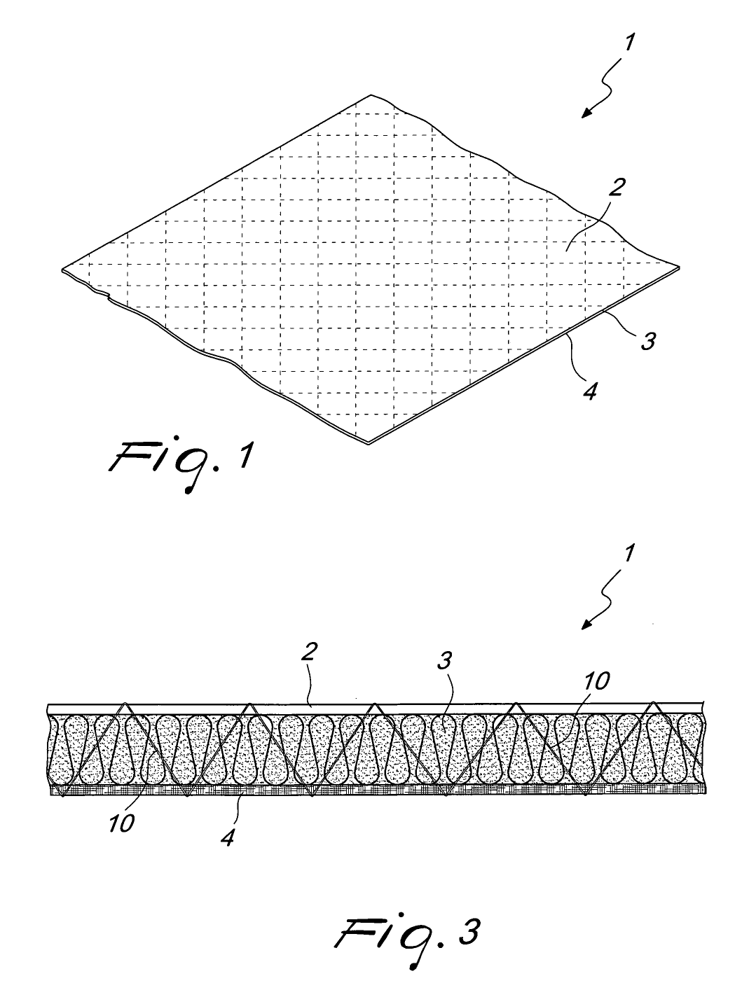

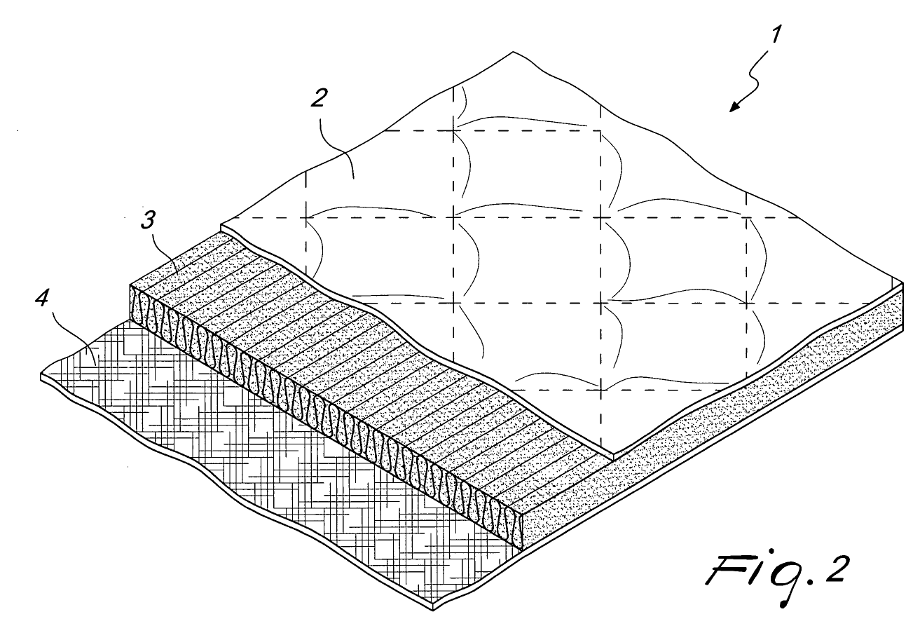

### DESCRIPTION OF THE PREFERRED EMBODIMENTS

With reference to the figures, the layered product with high thermal insulation and self-extinguishing capacity is generally designated by the reference numeral 1.

The layered product, which can be used for example to provide blankets, accessories for beds, upholstery, coverings, items of clothing and the like, comprises a first layer 2, which is provided by means of a fabric obtained with a yarn constituted by the intimate mixing of cellulose fiber and phenolic fiber.

The cellulose component provides the level of pleasantness to the touch, with a smooth and comfortable appearance, while the phenolic fiber, advantageously constituted by a novoloid fiber, provides the heat resistance function and the better tenacity during combustion.

Experimental tests that have been conducted have shown that the optimum ratio is achieved by using artificial cellulose fiber in a quantity of 60% by weight and 40% by weight of novoloid fiber.

An increase in novoloid fiber would provide a very limited improvement to the thermal insulation against heat, but would instead increase cost considerably.

The first layer 2 or outer layer is superimposed on an intermediate layer 3, advantageously provided by a cotton wool made of phenolic fiber, such as novoloid fiber, which is compressed so as to increase density and reduce its volume.

This aspect reduces the heat transfer rate, which with low-density cotton wools would accelerate heat conduction.

Advantageously, the thickness of the intermediate layer is at least 4 mm, preferably 5 mm, so as to retain a sufficient quantity of air, which becomes the best natural insulator, from a thermal standpoint.

The density of the cotton wool, with a thickness of 5 mm, can range advantageously from 150 g/m² to 250 g/m², preferably 200 g/m².

A second layer or outer layer 4 is applied to the intermediate layer, on the opposite face with respect to the one on which the first layer 2 is applied, predominantly has an aesthetic completion function and is obtained advantageously with an artificial cellulose fiber of the type used in a mix in the yarn for obtaining the first layer.

The use of an artificial cellulose fiber yarn has the purpose of achieving an optimum aesthetic and tactile aspect and of not emitting toxic fumes in case of combustion.

The second layer, which weighs approximately 120 g/m², can be subjected to dyeing or printing and it is further possible to enhance the luster characteristic with a mechanical finish by using a glazing calender.

The layers 2, 3 and 4 are stably joined to each other by way of connecting means which are advantageously provided by a quilting yarn 10, constituted advantageously by a natural cotton fiber selected with the criterion of non-toxicity.

The density of the quilting stitches 10 and the count used are such that they do not exhibit flame propagation capacity even by pyrolysis effect.

From what has been described above it is evident that a layered product is provided in which the surfaces can be dyed or printed and in which the first layer that constitutes the outer exposed side has extremely high characteristics of resistance to combustion and moreover the coupling of the provided layers allows to also obtain a thermal insulation barrier, thus providing a product which combines the typical characteristics of pleasantness and warmth with high-level characteristics of softness, attractiveness and aesthetics, together with the possibility of constituting a highly effective protective element which has the fundamental characteristic of not emitting toxic gases in case of combustion.

The invention thus conceived is susceptible of numerous modifications and variations, all of which are within the scope of the appended claims.

All the details may further be replaced with other technically equivalent elements.

In practice, the materials used, so long as they are compatible with the specific use, as well as the contingent shapes and dimensions, may be any according to the intended uses.

The disclosures in Italian Patent Application No. M12008A001354 from which this application claims priority are incorporated herein by reference.

What is claimed is:

1. A layered product with high thermal insulation and self-extinguishing capacity comprising a first layer constituted by a fabric obtained with a yarn provided by means of an intimate mix of cellulose fiber and phenolic fiber, said first layer being superimposed on an intermediate layer made of a phenolic fiber cotton wool, a second layer being further provided which is constituted by a fabric obtained with a cellulose fiber yarn associated with said intermediate layer on the opposite side with respect to said first layer, means for joining said layers being further provided.

2. The layered product according to claim 1, wherein said phenolic fiber is constituted by novoloid fiber.

3. The layered product according to claim 1, wherein said phenolic fiber is comprised in said first layer in a quantity equal to, or lower than, 50%.

4. The layered product according to claim 1, wherein said intermediate layer is made of novoloid fiber.

5. The layered product according to claim 1, wherein said cotton wool is in a quantity ranging from 150 to 250 g/m², with a thickness of said intermediate layer ranging from 4 to 5 mm.

6. The layered product according to claim 1, wherein said second layer is constituted by a fabric which has a weight ranging from 100 to 150 g/m².

7. The layered product according to claim 6, wherein said second layer is subjected to a mechanical gloss finish by means of a glazing calender.

8. The layered product according to claim 1, wherein said means for joining said layers comprise a quilting yarn.

9. The layered product according to claim 8, wherein said quilting yarn is constituted by a natural cotton fiber.
